(19) United States
(12) Patent Application Publication
(10) Pub. No.: US 2011/0210075 A1
(43) Pub. Date: Sep. 1, 2011

(54) ELECTROCOAGULATION DEVICES AND METHODS OF USE

(75) Inventors: Michael L. Enos, Colorado Springs, CO (US); Randal R. Gingrich, Monument, CO (US); William R. Henchel, Palmer Lake, CO (US)

(73) Assignee: AUXSOL, INC., Colorado Springs, CO (US)

(21) Appl. No.: 13/061,714

(22) PCT Filed: Sep. 2, 2009
(86) PCT No.: PCT/US09/55797

§ 371 Date: May 16, 2011

Related U.S. Application Data
(60) Provisional application No. 61/093,706, filed on Sep. 2, 2008.

(51) Int. Cl. C02F 1/463; C25B 9/00

(52) U.S. Cl. 210/702; 204/272; 205/742; 205/755

(57) ABSTRACT

The present invention provides electrocoagulation devices and methods for using the same to treat water to remove at least a portion of suspended, dissolved solids, or a combination thereof.

### CROSS-REFERENCE TO RELATED APPLICATIONS

This application claims the priority benefit of U.S. Provisional Application No. 61/093,706, filed Sep. 2, 2008, which is incorporated herein by reference in its entirety.

### FIELD OF THE INVENTION

The present invention relates to electrocoagulation devices and methods for using the same to treat water to remove at least a portion of suspended or dissolved solids.

### BACKGROUND OF THE INVENTION

A wide variety of chemical and mechanical processes have been developed in an effort to control pollution from industrial effluent streams and/or to treat other natural water sources as part of a larger water treatment system like those found in community water treatment facilities. Impurities in the streams can include suspended, colloidal and dissolved solids such as fine clay particles, iron, silica or organic or inorganic materials. Both chemical and mechanical methods have been employed to coalesce and coagulate these impurities. These impurities are then typically removed by any one or more of a variety of separation methods including filtration, centrifugation, as well as methods that use enhanced gravity settlers such as inclined plate settlers and/or clarifiers. The goal of these processes is to remove sufficient impurities to allow the effluent liquid to be discharged into the environment with an acceptable amount of adverse impact or to be reused in various applications or as a pre-treatment step in a larger water treatment system.

In some regions, community water supplies have high concentrations of naturally occurring radioactive materials (NORM) such as radium and uranium. These NORM materials are removed through a process which usually involves adding expensive chemicals to precipitate these NORM products which are then removed from the water supply.

The presence of microbes, e.g., bacteria, in water is often considered negative especially in water supplies that are consumed by humans. Microbes that are present in water supplies may cause diseases in livestock or humans. In some instances, microbes may foster the formation of various types of slime and/or sludge. Therefore, it is desirable to achieve an efficient microbe kill-rate in the course of any water treatment process.

In many oil and gas production processes, large volumes of highly contaminated, water (called “produced water”) (PW) is produced along with the production of hydrocarbons. For example, operators in the South Mid-continent Region of the Petroleum Technology Transfer Council (PTTC) have identified PW as a major constraint in the production of hydrocarbons. The costs of lifting, separating, handling, treating, and disposing of this water are substantial.

Much has been researched on the problems involving the use and disposal of water in oil and gas industry. This problem is more pronounced in the semi-arid regions of the Western U.S. However, even in regions where water is not as scarce, a large quantity of source water is used by the oil and gas industry. This creates a significant problem of treating and/or disposing of large volumes of contaminated PW. Because of these high water demand and disposal issues, the oil and gas industry competes with local industry, communities and environmentalists on water use and disposal issues.

Often, reusing untreated PW for well-fracturing (frac'ing) operations is not viable due to the large potential these waters have in fouling underground geologic formations, which then impedes the production of hydrocarbons. Fouling refers to the formation of slime and/or solids in the underground fracture matrix that reduces or prevents the release and flow of hydrocarbons. Typically, fouling in productive wells makes them less or non-productive.

Without being bound by any theory, the fouling or scaling potential (i.e., likelihood or probability of fouling or scaling) of PW is believed to be caused by high concentrations of colloids [e.g., total dissolved solids (TDS) and/or total suspended solids (TSS)] including iron, silica, sulfur compounds, carbonates, or a combination thereof. In some instances, the fouling or scaling potential is believed to be also caused by iron and/or sulfur reducing bacteria (IRB & SRB). Thus, reusing or discharging PW without treatment jeopardizes hydrocarbon production or creates serious environmental problems.

While there has been much research to address problems associated with disposing PW in the oil and gas industry, conventional processes generally require large amounts of harsh chemicals (e.g., caustics), making such treatments ineffective and/or not commercially economical.

Therefore, there is a need for more effective and/or economical processes to treat various water supplies.

### SUMMARY OF THE INVENTION

Some aspects of the invention provide an electrocoagulation device comprising an electrically conducting tube and an electrically conducting tube insert, and a non-electrically conducting connector that substantially isolates the tube and the tube insert electrically. The electrically conducting tube comprises: an inner diameter, an outer diameter, a first orifice, and a second orifice distal to the first orifice for allowing a fluid to flow out of the electrocoagulation device when in operation. The electrically conducting tube insert is typically located and positioned within the tube such that there is an annular space between the tube and the tube insert. The tube insert, which can include a solid portion or be hollow lengthwise with a closed distal end, comprises: a fluid inlet located proximal to the first orifice of the tube for allowing a fluid to flow into said electrocoagulation device, and a plurality of fluid outlet orifices. The plurality of fluid outlet allows a fluid to flow out of the tube insert and into the annular space of the electrocoagulation device. Typically, the plurality of fluid outlet is located proximal to the first orifice so that the fluid flows through the annular space substantially the entire length of the electrocoagulation device. The non-electrically conducting connector is typically located proximal to the first orifice and connects the tube and the tube insert such that the tube and the tube insert are electrically isolated from one another. One of the tube and the tube insert forms an anode and the other forms a cathode of the electrocoagulation device. In some embodiments, the tube comprises an electrical conduction point along the length of the tube. Typically within these embodiments, there is a plurality of electrical conduction points that are substantially regularly or evenly spaced.

In some embodiments, the tube is a metallic tube. Within these embodiments, in some instances, the tube comprises aluminum, copper, nickel, zinc, silver, titanium, iron, stainless steel, monel, or a combination thereof.

In other embodiments the tube insert comprises (a) an electrically conducting tube portion comprising the fluid inlet and the plurality of fluid outlet orifices and (b) an electrically conducting solid portion. Within these embodiments, in some instances the electrocoagulation device further comprises an electrical shielding element surrounding the electrically conducting tube portion such that when the device is in operation the flow of electricity between the electrically conducting tube and the electrically conducting tube portion is substantially reduced. Typically, the electrical shielding element is located in between the electrically conducting tube and the electrically conducting tube insert such that is surrounds or electrically shields substantially all of the plurality of fluid outlet orifices. Such a configuration allows the fluid to be substantially shielded from the electric field until it travels down the annular space.

Still in other embodiments, the electrically conducting tube portion and the electrically conducting solid portion are removably attached from one another. In this manner, one can readily replace the electrically conducting solid portion.

Yet in other embodiments, the solid portion comprises a metal, electrically conducting polymer, or a combination thereof. Within these embodiments, in some instances the solid portion comprises aluminum, iron, or a combination thereof. And within these instances, in some cases the solid portion comprises a mixture of material comprising iron and aluminum.

Yet in other embodiments, the electrically conducting solid portion comprises a plurality of protuberances. Typically, each of the protuberance comprises a non-electrically conducting material thereby preventing a direct electrical contact between the tube and the tube insert.

Still in other embodiments, the tube insert comprises a plurality of protuberances. Within these embodiments, in some instances the plurality of protuberances comprises a non-electrically conducting material.

In other embodiments, each of the fluid inlet and the second orifice further comprises a T-joint adapted to allow purging of the electrocoagulation device.

In some embodiments, the outer surface of the tube insert and/or the inner surface of the tube are designed or treated to increase the fluid turbulence as it flow through the electrocoagulation device.

Yet in other embodiments, the plurality of fluid outlet orifices, the surface of the tube insert and/or the inner surface of the tube are designed and constructed to generate cavitation in fluid being treated.

In some embodiments the tube is fitted with jets which allow the injection of the fluid (e.g., water and/or gases) into the annular space.

Still in other embodiments, the fluid inlet and/or the outlet portions of the tube are fitted with a venturi device thereby permitting the injection of fluids (e.g., liquids and/or gases) into the fluid stream.

In some embodiments, the fluid inlet and/or the outlet portions are fitted with a in-line mixing device to promote mixing.

In some embodiments, the electrocoagulation device further comprises an electric power supply that is operatively connected to the electrocoagulation device. The power supply provides electricity to the electrocoagulation device. In some instances, the power supply provides alternating current (AC) (or voltage) to the electrocoagulation device. In other instances, the power supply provides direct current (DC) (e.g., non-alternating voltage) to the electrocoagulation device. Still in other instances, the power supply provides pulsed positive and/or negative voltage or current pulses to the electrocoagulation device. For example, the power supply applies the voltage (or current) intermittently.

In other embodiments, the power supply comprises an amplitude control unit. In this manner, the amount of current and/or voltage can be set to a desired level. In addition the duty cycle and/or the pulse-width can be set to a desired level.

Still in other embodiments, the power supply comprises a voltage control unit. In this manner, the amount of current and the voltage can be regulated independently or set to desired operating limits.

Yet in other embodiments, the power supply provides pulsed DC voltage to the electrocoagulation device. Thus, unlike alternating current where the polarity of the inner and the outer tubes are switched, the pulsed DC voltage keeps the polarity of the inner and the outer tubes same while providing the voltage and/or current intermittently. Again in this or other pulsing embodiments, the duty cycle and/or the pulse width can be set to desired operating limits.

Another aspect of the invention provides a process for removing at least a portion of suspended or dissolved solids and at least a portion of hardness ions from water comprising the same. The process generally comprises:
flowing the water through an electrocoagulation device described herein to produce a solid precipitate and separating at least a portion of the solid precipitate from the water;
adding a carbonate ion source to the water under conditions sufficient to precipitate at least a portion of hardness ions as a carbonate precipitate; and
separating the carbonate precipitate from the water.

The electrocoagulation device can be one of the embodiments described herein or alternatively can comprise:
an outer conducting tube connected to an electrical source and comprising:
   an inner diameter;
   an outer diameter;
   a first open end; and
   a second open end that is distal to the first open end and is adapted to allow a fluid to flow out of the electrocoagulation device;
a tube insert connected to an electrical source and is axially aligned and positioned within the outer conducting tube such that the tube insert has no direct electrical connection to the outer conducting tube, wherein the tube insert comprises:
   an inner diameter;
   an outer diameter that is smaller than the inner diameter of the outer conducting tube thereby forming an annular space between the outer conducting tube and the tube insert;
   a fluid inlet that is positioned proximal to the first open end of the outer conducting tube; and
   a plurality of radially positioned fluid outlet ports; and
a cap that seals the first open end of the outer conducting tube and removably attaches the tube insert to the outer conducting tube without providing any direct electrical contact between the tube insert and the outer conducting tube,
   whereby the fluid flows into the device via the fluid inlet of the inner conducting tube, through the plurality of radially positioned fluid outlet ports and into the annular space, and exits the device via the second open end of the outer conducting tube while being subjected to electric current within the device.

In some embodiments within this process, the step of removing at least a portion of the hardness ions is conducted prior to the step of flowing the water through the device. In other embodiments, the step of flowing the water through the device is conducted prior to the step of adding a carbonate ion source to the water.

Yet in other embodiments, at least a portion of the solid precipitate is removed prior to adding a carbonate ion source to the water.

In some embodiments, the carbonate ion source is added to the water prior to removing the solid precipitate. Still in other embodiments, the carbonate ion source is added to the water substantially concurrently to said step of flowing the water through the device.

In some instances, the carbonate ion source comprises trona, an alkaline metal carbonate, an alkaline earth metal carbonate, an alkaline metal bicarbonate, an alkaline earth metal bicarbonate, carbon dioxide, or a mixture thereof.

Another aspect of the invention provides a water treatment process for treating water from hydrocarbon recovery processes, said treatment process comprising:

removing at least a portion of suspended and/or dissolved fine solids by electrocoagulation process; and
removing at least a portion of the bacterial population that is present in the water.

Another aspect of the invention provides a water treatment process for treating surface or ground water, said treatment process comprising removing at least a portion of NORM by electrocoagulation process.

In some embodiments, the electrocoagulation process uses any embodiment of the electrocoagulation device described herein.

Still in other embodiments, the process further comprises maintaining pH of the water in the neutral range of about pH 6.0 to pH 8.5.

In some embodiments, chloride ions present in the water are subjected to an electrolytic process to produce various levels of hypochlorous acid. Such processes provide oxidizing and/or biocidal agents.

Still in other embodiments, an oxidizing agent can be added to the fluid prior to subjecting the fluid to an electrocoagulation process described herein. There are a variety of oxidizing agents known to one skilled in the art including, but not limited to, chlorine dioxide, bleach, ozone, etc. Typically, these oxidizing agents can be used to oxidize iron, sulfur ions, and/or organic compounds that maybe present in the fluid. In some instances, the oxidizing agents also aid in reducing the number of microbes such as bacteria, including, but not limited to, iron reducing bacteria and sulfur reducing bacteria. In some instances, addition of an oxidizing agent facilitates precipitation of suspended solids, for example, solids that will bind with iron hydroxides.

Processes of the invention can be conducted in many different combinations. In some embodiments, the step of removing at least a portion of suspended or dissolved fine solids is conducted prior to the step of hypochlorous acid formation. In other embodiments, the step of hypochlorous acid formation is conducted prior to the step of removing at least a portion of suspended or dissolved fine solids. Still in other embodiments, hypochlorous acid formation is carried out substantially simultaneously with the electrocoagulation process.

In some embodiments, the process further comprises the step of producing hydroxide ions from water molecules. Within these embodiments, in some instances hydroxide ions are produced by corona discharge, sonic or ultrasonic cavitation, hydrodynamic cavitation, electron beam, particle beam, electrolysis, radio frequency energy, photonic energy, various sources of radiation or a combination thereof.

Still other aspects of the invention provide a water treatment process for treating water comprising suspended solids, dissolved fine solids, or a combination thereof. The water treatment process typically comprises: precipitating a significant portion of suspended or dissolved fine solids by electrocoagulation process using an electrocoagulation device disclosed herein; and separating the precipitated solid to produce a treated water.

In some embodiments, the water treatment process further comprises removing a hardness ion from the treated water. Typically, the hardness ion is selected from the group consisting of calcium, magnesium, strontium, barium, and a mixture thereof.

Generally, precipitating hardness ions comprises adding a carbonate source to the treated water. In this manner, the hardness ions precipitate as a carbonate. Typically, the carbonate source comprises trona, an alkaline metal carbonate, an alkaline earth metal carbonate, an alkaline metal bicarbonate, an alkaline earth metal bicarbonate, carbon dioxide, or a combination thereof.

Still in some embodiments, the water treatment process further comprises removing at least a portion of chloride ions that is present in the water. In many instances, removing chloride ion comprises an electrolytic process. Without being bound by any theory, it is believed that such processes initially convert chloride ions to chlorine gas. Electrolytic processes for converting chloride to chlorine is well known to one skilled in the art.

Yet in other embodiments, the water treatment process further comprises non-chemically generating hydroxide ions from water molecules. By “non-chemically generating hydroxide ions,” it is meant that hydroxide ions are generated by means other than a direct chemical reaction. In other instances, non-chemically generating hydroxide ions comprises using corona discharge, sonic cavitation, hydrodynamic cavitation, electron beam, particle beam, or a combination thereof. Generally, it has been found by the present inventors that in some instances, increasing the EC cell current and/or residence time of the fluid within the electrocoagulation devices of the present invention result in increased production of hydroxide ions.

In other embodiments, the water treatment process further comprises precipitating at least a portion of ferric ions, aluminum ions, silica, hydrocarbon, or a combination thereof.

### BRIEF DESCRIPTION OF THE DRAWINGS

FIGS. 1-2 are schematic drawings of various views of one particular embodiment of an electrocoagulation device of the present invention.

### DETAILED DESCRIPTION OF THE INVENTION

A wide variety of chemical and mechanical processes have been developed in an effort to control pollution from effluent streams such as in oil and gas production. Impurities in these streams include colloids (e.g., suspended solids and/or dissolved particles) as well as various ions. Many chemical and mechanical methods have been used to cause the impurities to coalesce and/or ions to precipitate to permit removal by filtration, centrifugation, separation, clarification, etc. The goal of the processes is to remove sufficient impurities to allow the treated water to be discharged into the environment or recycled and reused in fracing or other oil field or industrial uses with an acceptable amount of adverse impact or to be reused in various applications.

In some oil and gas production processes, a large volume of water is produced and/or used. For example, recovery of hydrocarbon (e.g., oil) from underground reservoirs often results in concomitant recovery of underground water. In other instances, a large volume of water is used to help facilitate or enhance hydrocarbon recovery from underground reservoirs. The resulting water is contaminated with colloids and various metallic (e.g., hardness) ions and requires removal of these contaminants prior to disposal or re-use.

Conventional processes that treat produced water (PW) from hydrocarbon recovery processes tend to over treat water without regards to the nature of contaminants. Such blanket approaches significantly increase the cost of treating PW and/or add a significant amount of time to treat PW, particularly if the water is to be returned to the oil and gas field for reuse verses a higher treatment and quality obtained for discharge into the environment. Furthermore, conventional processes often remove carbonate ions from the water.

In contrast, methods of the invention can include adding carbonate ion source to the PW. Such addition of carbonate ions is based on the analysis of the PW by the present inventors. In particular, it has been found by the present inventors that some PW includes a significant amount of hardness ions. By adding a source of carbonate ions, rather than removing them, it has been found by the present inventors that hardness ions and other heavy metal ions can be removed from the PW by precipitation. As used herein, the term “hardness ion” refers to metallic ions that are known to cause scaling. Typically, the hardness ions have what is considered a reverse solubility profile. That is, in contrast to most other ions, solids of these ions (especially carbonate solids) are more soluble as the temperature of the solution decreases. Exemplary hardness ions include calcium, magnesium, manganese, strontium, copper, iron and barium.

Another aspect of the invention provides processes for removing colloids (e.g., suspended or dissolved solids) that are present in the PW. In particular, methods of the invention use an electrocoagulation process to facilitate coagulation and/or precipitation of colloids. In this regard, water treatment processes of the invention generally relate to using any of the electrocoagulation devices known to one skilled in the art. However, methods and processes of the invention often relate to using any one of the electrocoagulation devices disclosed herein.

### Electrocoagulation Device

Some aspects of the electrocoagulation devices of the present invention will now be described with regard to the accompanying drawings which assist in illustrating various features of the invention. In this regard, some aspects of the present invention relate to electrocoagulation devices that comprise a tube and a tube insert. That is, some aspects of the invention relate to electrocoagulation device configurations comprising a tube and a tube insert positioned within the tube. It should be appreciated that all of the accompanying drawings are provided solely for the purpose of illustrating the various configurations of the electrocoagulation devices of the invention and do not constitute limitations on the scope thereof. Some aspects of the electrocoagulation process aspect of the invention relate to facilitating precipitation of colloids, suspended solids, and/or ions.

Without being bound by any theory, it is believed that in a typical electrocoagulation device sacrificial electrodes are used to generate the coagulating agent—generally aluminum or iron ions. Once the water has been treated by the electrocoagulation device, it is typically filtered, allowed to settle or sent to a gas or air flotation unit to remove the contaminants. Electrocoagulation process offers a number of potential advantages.

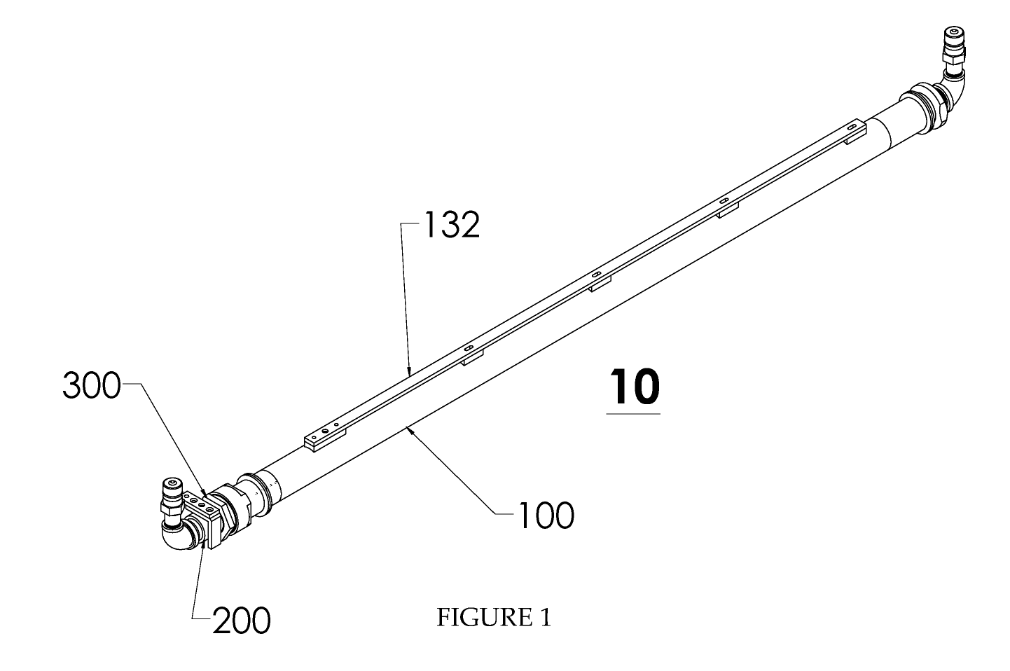

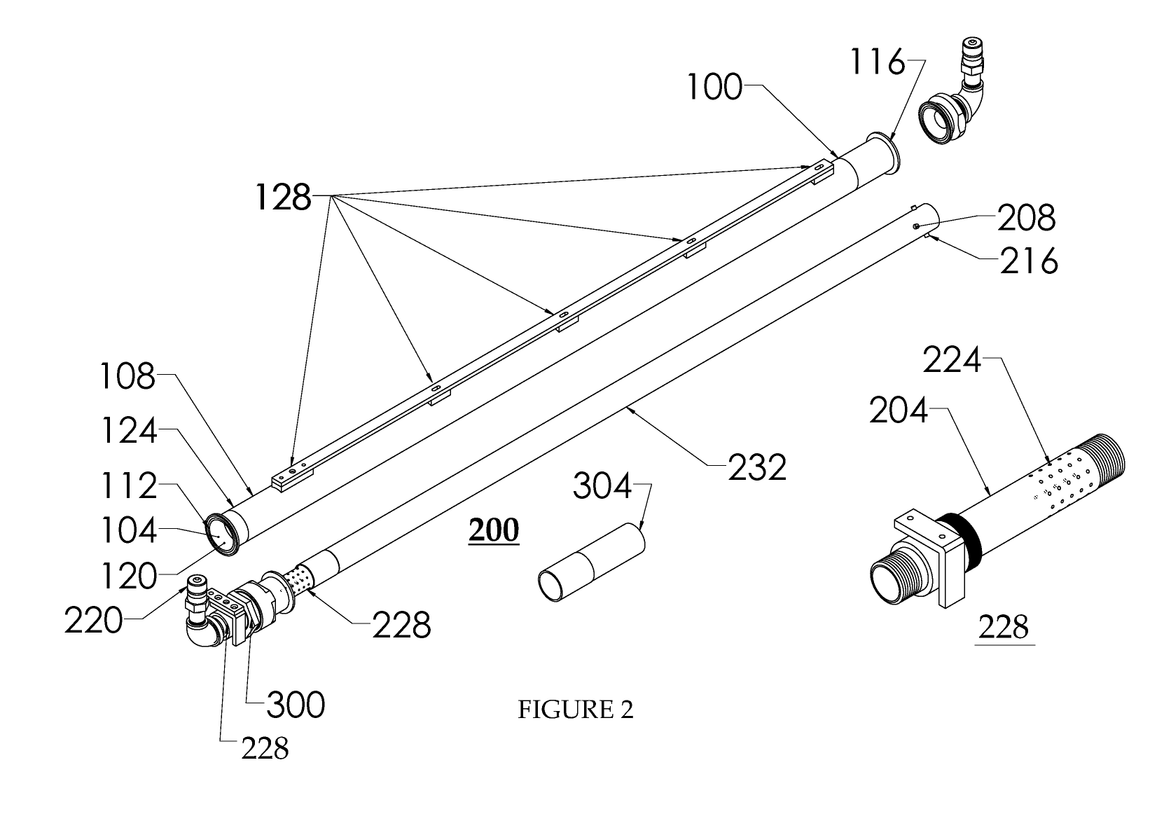

Referring to FIGS. 1-2, some aspects of an electrocoagulation device 10 comprises an electrically conducting tube 100, an electrically conducting tube insert 200 that is located and positioned within tube 100, and a non-electrically conducting connector 300. The inner diameter 104 of tube 100 and the outer diameter 204 of tube insert 200 are selected such that there is an annular space (not shown) between tube 100 and tube insert 200 to allow flow of a fluid within electrocoagulation device 10.

Tube 100 also includes an outer diameter 108, a first orifice 112, and a second orifice 116. Second orifice 116 is located distal to first orifice 112 and is configured to allow a fluid to flow out of electrocoagulation device 10. In operation, tube insert 200 is inserted into tube 100 through first orifice 112. In some embodiments, tube insert 200 includes one or more of spacer elements 208 which prevents a direct contact between inner surface 120 of tube 100 and the outer surface of tube insert 200. In some instances, spacer element 208 comprises a plurality of protuberances 216. Within first orifice 112, non-electrically conducting connector 300 is positioned between tube 100 and tube insert 200 thereby electrically isolating tube 100 and tube insert 200. It should be appreciated that tube insert 200 can be held within tube 100 using any connecting mechanism known to one skilled in the art including, but not limited to, nut-and-bolt configuration, and simply by snugly fitting non-electrically conducting connector 300 into first orifice 112 and then snugly fitting tube insert 200 within non-electrically conducting connector 300. Regardless of the connecting mechanism used, tube 100 and tube insert 200 are connected using a connecting mechanism that has a sufficient resistance or friction to withstand any fluid pressure that is applied to electrocoagulation device 10.

In some embodiments, outer surface 124 of tube 100, includes a plurality of electric nodes 128 and optionally conducting element 132. One of the purposes of having conducting element 132 is to evenly distribute electric current throughout the entire tube 100 through each of the electrical contact points 128 simultaneously. However, it should be appreciated that conducting element 132 is not required as one can simply attach an electrical wire (not shown) to each of electric node 128 directly to achieve a similar result. Without being bound by any theory, the conducting element 132 distributes the current across the tube 100, thereby providing a substantially even electrolysis across the length of the tube insert 200 resulting in prolonged life of the tube insert 200. In some instances, it has been found by the present inventors that use of a plurality of electric nodes 128 prevents a single point of contact that can “burn” a hole in the tube 100.

Tube 100 can comprise any material as long as voltage can be applied to allow flow of electricity between tube 100 and tube insert 200 when in operation. Typically, tube 100 comprises a metal or an electric conducting polymer. Exemplary materials of which tube 100 can comprise include, but are not limited to, aluminum, copper, nickel, zinc, silver, titanium, iron, stainless steel, monel, and a combination thereof.

Tube insert 200 can be a single piece or it can comprise two or more pieces that are joined together as long as the materials used for tube insert 200 are electrically conducting such that electricity flows between tube 100 and tube insert 200 during operation. Tube insert 200 comprises a fluid inlet 220 and a plurality of fluid outlet orifices 224. Fluid inlet 220 is typically located proximal to first orifice 112. In operation, a fluid enters electrocoagulation device 10 through fluid inlet 220 and exits tube insert 200 through fluid outlet orifices 224. The fluid then travels down the annular space (not shown) between tube 100 and tube insert 200 while being subjected to electricity and exits through second orifice 116.

Tube insert 200 can be a tube having a closed distal end (distal relative to fluid inlet 220) or it can comprise two or more separate elements that are connected together. In some embodiments, tub insert 200 comprises an electrically conducting tube portion 228 and an electrically conducting solid portion 232. It should be appreciated that electrically conducting solid portion 232 need not be solid throughout: it can be a tube that is closed on both ends. Generally, different elements of tube insert 200 are interconnected such that it allows application of voltage through substantially the entire length of tube insert 200. Interconnection of different elements of tube insert 200 can be achieved using any of the connecting methods known to one skilled in the art including permanent connection and removable connection. For example, electrically conducting tube portion 228 and electrically conducting solid portion 232 can be removably attached by a snap-and-plug mechanism or by a nuts-and-bolt mechanism; or it can be permanently attached, e.g., by soldering the two elements together. It has been found by the present inventors, that using a removably attachable mechanism allows facile replacement of the electrically conducting solid portion 232, which wears or degrades faster than electrically conducting tube portion 228 in certain embodiments. In some embodiments, the electrically conducting tube portion 228 comprises a plurality of radially positioned fluid outlet orifices 224. In some cases, the electrically conducting tube portion 228 is electrically shielded, e.g., using a non-electrically conducting shield 304.

As stated above, in some embodiments, tube insert 200 comprises a plurality of spacer elements 208 to avoid direct contact between tube insert 200 and tube 100. Spacer element 208 is typically made from a non-electrically conducting material, such as Teflon® or other non-electrically conducting polymer or material. Spacer element 208 can be attached to tube insert 200 using any of the methods known to one skilled in the art. For example, spacer element 208 can be (1) a ring of non-electrically conducting material to which tube insert 200 is inserted; (2) a plurality of a portion of a ring (e.g., an arc configuration) placed within different portions of tube insert 200 to allow tube insert 200 to be placed within inner diameter 104 of tube 100 without allowing a direct contact between tube insert 200 and tube 100; (3) one or more spacer inserts within tube insert 200 such that one or more ends of the spacer insert protrude out of tube insert 200, thereby preventing tube insert 200 from contacting tube 100.

In some embodiments, the electrically conducting tube portion 228 comprising the plurality of fluid outlet orifices 224 is electrically shielded by placing an electrical shielding element 304 between tube 100 and the electrically conducting tube portion 228. In some embodiments, electrical shielding element 304 is as long as or slightly longer than the length of electrically connecting tube portion 228, thereby shielding the entire length of electrically connecting tube portion 228. Without being bound by any theory, it is believed that by placing electrically shielding element 304, flow of electricity between tube 100 and electrically conducting tube portion 228 comprising the plurality of fluid outlet orifices 224 is substantially reduced, thereby substantially extending the life of electrically connecting tube portion 228.

In some embodiments, electrocoagulation device 10 also includes means for purging the annular space to flush out any solid residues that may have accumulated or built-up during operation. It has been found by the present inventors that in certain instances the efficiency of electrocoagulation device 10 decreases as its operation time increases. By flushing out the solid materials or build-ups that accumulate within electrocoagulation device 10, the present inventors have found that at least some of the efficiency can be restored. In some embodiments, a mechanism for purging electrocoagulation device 10 includes having T-joints (not shown) proximal to fluid inlet 220 and second orifice 116. The presence of such T-joints allows flushing electrocoagulation device 10 to be achieved without disconnecting from operation.

Current from a power source (not shown) provides power to electrocoagulation device 10. A power supply (not shown) can be used to apply different current through the device.

In one embodiment, the power source provides DC power thereby allowing a constant anode or cathode configuration. In another embodiment, the power source provides periodic AC power thereby alternating anode and cathode configuration temporarily for tube 100 and tube insert 200. When using an AC power source, the polarity of tube 100 and tube insert 200 can change (i.e., switch) at a desired time intervals. Such switching can be done automatically using a timer or some other device that controls the voltage. One of the advantages of using a periodic AC power source is that it significantly reduces the amount of electrical resistance increase due to the build-up of solids (e.g., salts, metallic carbonates and hydroxides) around the metal tube, thus resulting in less maintenance.

When in use, aqueous solution enters tube insert 200 through fluid inlet 220. The aqueous solution then enters the electrically conducting tube portion 228 into the annular space (or cavity, not shown) between tube 100 and tube insert 200 through a plurality of fluid outlet orifices 224 which are located in tube insert 200. The aqueous solution then travels down the cavity or annular space and exits electrocoagulation device 10 through second orifice 116. Typically, the plurality of fluid outlet orifices 224 is located distal to second orifice 116 to maximize or to provide a relatively long contact time with inner surface 120 of tube 100 and outer surface of tube insert 200. The treated aqueous solution is then discharged through second orifice 116. The solids in the treated aqueous solution are then separated from the liquid with a filter or by retaining it for a period of time in a settling tank or basin (not shown) or by any other methods known to one skilled in the art. As stated above, the negative and positive polarity of the metal tubes can be periodically reversed, either mechanically or automatically, so as to, among others, aid in the cleaning of the cathode portion.

The device described above provides a strong, quick settling, low volume flocculates. Without being bound by any theory, it is believed that the electrocoagulation device of the present invention generates, among others, aluminum hydroxide and/or iron hydroxide. The formation of metal hydroxides is advantageous in that the metal hydroxide is useful in encouraging a coagulating reaction on suspended and colloidal solids.

It is also believed that in addition to the formation of metal hydroxides, the electrocoagulation device of the instant invention also generates, in some instances, metal oxides and complex metal oxides or precipitates. Oxides of this type can, for example, be of iron, nickel, aluminum, chromium, or the like.

Optionally, if brine concentrations are not too high, a complexing agent can also be added to the aqueous solution prior to, during or after undergoing an electrocoagulation process. Exemplary complexing agents include PAC1 (Poly aluminum chloride). However, typically the methods of the invention do not require any complexing agents, thereby significantly reducing the cost and the chemicals that need disposal.

In addition to the normal oxidation reaction which takes place at the anode, in some instances an oxidizing agent, e.g., ozone, can be injected into the influent stream to oxidize, destroy, and/or degrade at least some of the organic compounds that maybe present in the aqueous solution. Hydrogen can also form at the cathode. In some instances, hydrogen gas bubbles, which float the formed waste (e.g., flocculates) to the surface of the solution where they can be skimmed off.

Methods of the invention can also include adding materials to the aqueous solution to be treated. Such materials include acids, bases, polymers, air, oxygen, carbon dioxide, ozone, carbonate ion sources, etc.

In some instances, precipitated colloids and carbonates that are formed within the annular space (e.g., along the cathode wall) by the electrocoagulation process can be separated or removed by adding hydrochloric acid into the influent stream, or the like into the liquid or aqueous solution. Such a process allows the solids to be removed from the cathode wall or the annular space and the resulting metal ions are discharged in the subsequent settling process and removed. Removing cathodic buildup reduces the electrical resistance of the electrocoagulation device, thereby allowing the electrocoagulation process to be operated at a lower voltage. This reduction in current or voltage increases the life span of the electrocoagulation device.

### S_{R}: The Scaling Ratio

There are several indices that define a water samples' ability to form scale such as the Langelier Saturation Index or the Ryznar Scaling Index. However, these indices tend to loose their effectiveness when applied to water samples such as PW due to the large amount of ions. Therefore, it is convenient to define a figure of merit in order to allow comparison of a wide range of water types called the Scaling Ration or S_{R}, which is defined as:

$${S}_{R} = log ( \frac{Total\_Alkalinity}{Total\_Hardness} )$$

where S_{R} is the log of the ratio of Total Alkalinity ions (measured in mg/L) to Total Hardness ions (also in mg/L) concentrations. An S_{R}=0 indicates an equal concentration of Alkalinity to Hardness ions. An S_{R}=+1 indicates a concentration of alkalinity ions 10× larger than hardness ions while an S_{R} of −1 indicates Hardness ions are 10× more common than alkalinity ions.

While other conditions maybe important, in general, water samples which have S_{R} values >0 have a larger potential to form scale than samples with S_{R} values <0. Typically, the total hardness is reported as the amount of CaCO₃, however this doesn't mean that all the hardness is in the form of calcium carbonate. This is merely a convenient method used to report hardness, where all the sources of hardness have been mathematically (e.g., Ca²⁺ concentrations×2.5) converted to units of CaCO₃, allowing an easier way to report results.

Alkalinity is generally a measure of a water sample's basicity or ability to resist a pH change with acid addition. In PW, alakalinity of water typically results from the presence of hydroxide (OH⁻), bicarbonate, (HCO₃⁻) and carbonate (CO₃²⁻) ions. Thus, S_{R} is a figure of merit useful for indicating a water sample's ability to scale in a closed system given a set of conditions (a system where no additional alkalinity or hardness sources are available). The stoichiometric equations governing scaling is discussed below.

Sₚ: Scaling Potential

Another useful quantity that can be defined is the Scaling Potential or S_{P} which is the sum of known scaling species present as expressed by the following equation (concentrations in meq/L):

$${S}_{P} = \sum ( [ {Ca}^{2 +} ] + [ {Mg}^{2 +} ] + [ {Sr}^{2 +} ] + [ {M}^{2 +} ] ) \frac{meq}{L}$$

where [M²⁺] refers to the concentration of additional divalent hardness ions which may be present. S_{P} is an indicator of a water sample's total potential to scale.

In a closed water system which has a Sₚ<0 (alkalinity ions in short supply relative to hardness ions), S_{P} is a figure of merit to indicate how much scaling could occur if a sufficient concentration of alkalinity ions were available. Scaling depletes the concentrations of scaling species as they are consumed in the scaling reaction. Once these species are depleted, the sample's S_{P} is reduced to 0 and no further scaling is possible.

For a closed system, scaling will typically be inhibited once the ion present in the lowest concentration has been depleted. This is true even in the presence of vast quantities of the counter-ion. However, the fluid has further potential for scaling if more of the depleted ion is made available. The scaling reaction can then continue, however, to the point until the entire concentration of total hardness ions have been consumed.

Some industrial process water for systems such as boilers and evaporators have source water which is relatively “clean” compared to typical oil field PW. S_{R} for these waters is on the order of zero indicating they have closely matched concentrations of alkalinity ions and hardness ions and can readily scale given the right conditions.

S_{P} in these systems typically fall in the range of 1-20 meq/L, therefore even though S_{P} for these waters are much lower than oil field PW, because of the relative equality of alkalinity ions to hardness ions scaling will occur under proper conditions. When scaling occurs, Ca, Mg and Sr ions form carbonate compounds such as calcium carbonate (CaCO₃), magnesium carbonate (MgCO₃) and strontium carbonate (SrCO₃) which are relatively insoluble in water (e.g., CaCO₃ solubility in water under standard condition is around 18 mg/L); therefore, these compounds readily precipitate under the correct pH and temperature conditions.

Unlike conventional salts, calcium carbonate has a reverse solubility. That is, calcium carbonate dissociates at lower pH and/or lower temperature. Conventional anti-scaling methods target modification of process water chemistries to either force or suppress precipitation of carbonate compounds. This is achieved by a number of methods but most involve modifying pH (caustic addition) at elevated temperatures. However, this strategy is generally useful when the S_{R} is on the order of unity.

Typically, oil field PW stands in contrast with most industrial process water in which scaling is being addressed. For example, one particular oil field PW analysis showed the following scaling ratio and scaling potential:

$${S}_{R} = log ( \frac{210}{23000} ) = - 2.039$$

$${S}_{P} = \sum ( 387.82 + 67.96 ) = 455.69$$

S_{P}=455.69 indicate the water has tremendous potential to scale (e.g., typical drinking water has S_{R}˜1-10). However, S_{R}=−2.039 indicates that few alkalinity ions are available for scaling relative to the availability of hardness ions. Therefore, the scarcity of alkalinity ions will inhibit the water's ability to scale. Thus, even though the tested oil field PW is very rich in scaling ions, in a closed system, scaling will be almost non-existent. Therefore, to remove and precipitate scaling species, additional alkalinity ions are needed.

When this PW water is reinjected into a well, additional alkalinity ions become available from the underground reservoir. In combination with the high concentrations of hardness ions present the scaling potential becomes very significant when the treated PW water is reinjected into an oil well. One can substantially reduce this scaling potential by removing hardness ions such as calcium, magnesium, and strontium ions, etc.

Another aspect of the invention provides adding a carbonate ion source to the aqueous solution to remove at least a portion of calcium ions as well as other metal ions that form precipitates. Because the solubility constant for the calcium carbonate is low, by adding a carbonate ion source the equilibrium is driven towards precipitation of calcium carbonate. The carbonate ion source can be added prior to, during, and/or after electrocoagulation process.

It should be noted that conventional water treatment process typically removes carbonate ions. In contrast, some methods of the invention add a carbonate ion source. It has been found by the present inventors that addition of a carbonate ion source aids in removal of various metal ions including calcium, magnesium, strontium, etc. by precipitating these ions as carbonate salts. In particular, some aspects of the invention utilize the various equilibrium relationships between water, CO₂, carbonic acid (or carbonate) and bicarbonate ions.

The following set of equations generally describes various equilibrium relationships. In one particular instance, the process starts with dissolving gaseous CO₂ into water according to the equilibrium equation:

CO₂ Dissolves into Solution

CO₂(g) [symbol] CO₂(aq) Equation 1

Equilibrium of CO₂ with Carbonic Acid

CO₂(aq)+H₂O [symbol] H₂CO₃(aq) Equation 2

Equilibrium of Carbonic Acid with Bicarbonte Ion

H₂CO₃⁻+H₂O [symbol] H₃O⁺+HCO₃⁻ Equation 3

Equilibrium of Bicarbonate Ions with Carbonate Ions

HCO₃⁻+H₂O [symbol] H₃O⁺+CO₃²⁻ Equation 4

Finally, the last step of the process is for carbonate ions to combine with scaling species to form precipitates:

Calcium Carbonate Precipitates

Ca²⁺+CO₃²⁻→CaCO₃(ppt) Equation 5

Magnesium Carbonate Precipitates

Mg²⁺+CO₃²⁻→MgCO₃(ppt) Equation 1

Strontium Carbonate Precipitates

Sr²⁺+CO₃²⁻→SrCO₃(ppt) Equation 2

The above carbonate compounds have very low solubility in water under typical conditions. In order for these compounds to redissolve, typically the pH of the solution need to be lowered significantly, e.g., often to at least 5 or below.

By combining the electrocoagulation process with this equilibrium relationship, methods of the invention provide a unique process for treating PW. In some aspects of the invention, addition of a carbonate ion source also includes controlling or adjusting the pH of the solution.

Controlling or adjusting the pH is based on the equilibrium relationship between pH and various ions such as H₂CO₃, HCO₃⁻¹, and/or CO₃⁻². From the equilibrium curve shown in FIG. 7, it can be seen that at or below about pH=4 or 5 the predominant species is CO₂. As the pH continues to increase, bicarbonate ion predominates from about pH=6.5 to about pH=10.5. As can be seen in FIG. 7, it is not until about pH=8 or 8.5 the carbonate ion appears in the solution. Accordingly, some embodiments of the invention include maintaining the pH of the solution to about pH 6.5 or higher, typically about pH 7.5 or higher, often about pH 8 or higher, and more often about pH 8.5 or higher. It should be appreciated, however, FIG. 7 represents equilibrium curve at a particular condition, e.g., at a particular solution temperature. Accordingly, methods of the invention are not limited to the specific pH ranges and examples disclosed herein. One skilled in the art can readily determine the applicable pH ranges for particular conditions.

In accordance with the Le Chatlier's principle it is expected that formation of metal carbonate, e.g., CaCO₃, precipitates will continue as long as the solution conditions (e.g., pH) are maintained. Formation of metal carbonate precipitate reduces the amount of carbonate ions in the solution. And according to the Le Chatlier's principle, the equilibrium continue to be driven to the formation of carbonate ions in the solution.

Various parameters and/or conditions can affect precipitation of scaling species. For example, sodium hydroxide reacts with carbon dioxide to generate a carbonate species according to the following equation:

Sodium Hydroxide Reacts with CO₂

CO₂+2NaOH→Na₂CO₃+H₂O Equation 8

Precipitation of Ca⁺² Ions

Na₂CO₃+Ca⁺²→CaCO₃+2Na⁺² Equation 9

As discussed above, in contrast to most conventional water treatment methods, some aspects of the invention add rather than remove a carbonate ion source. As used herein, the term “carbonate ion source” refers to any chemical or agent that generates carbonate ion in aqueous solution under proper conditions. Exemplary carbonate ion sources include trona, alkaline metal carbonates and bicarbonates, alkaline earth metal carbonates and bicarbonates, carbon dioxide, and the like. In addition, some embodiments of the invention include using a mechanical device that aids in dissolving carbon dioxide into an aqueous solution. Such devices are well known, for example, in fountain beverage dispensing.

In some instances, methods of the invention substantially eliminate or significantly reduce visually detectable turbidity in PW after flocculate settling.

Another aspect of the invention provides a method for removing chloride ions in the aqueous solution. Typically, any conventional chloride ion removal process can be used. In one particular embodiment, chloride ions are removed by electrolytic process which converts the chloride ions to chlorine gas. It should be appreciated that in many instances, chlorine gas reacts with water to produce hypochlorous acid which can oxidize iron ions (if present) to revert back to chloride ions.

Additional objects, advantages, and novel features of this invention will become apparent to those skilled in the art upon examination of the following examples thereof, which are not intended to be limiting.

### EXAMPLES

### Example 1

Water that was recovered from a produced water gas well in Texas was analyzed, and the results are shown in Table 1 below.

TABLE 1
Analysis result of water from an oil recovery process.

| Cations | | Anions | |
|---|---|---|---|
| Ion | Concentration (mg/L) | Ion | Concentration (mg/L) |
| Na⁺ | 30420.00 | Cl⁻¹ | 74780.00 |
| Ca⁺² | 7818.00 | HCO₃⁻¹ | 161.74 |
| Sr⁺² | 1224.00 | SO₄⁻² | 97.60 |
| Mg⁺² | 844.00 | CO₃⁻² | 1.00 |
| K⁺ | 512.00 | | |
| Ba⁺² | 38.44 | | |
| Fe⁺² | 36.05 | | |
| Al⁺³ | 6.40 | | |

### Example 2

The following table shows the before and after result of treating water of Example 1 in accordance with the invention. These analytical results shown were produced by processing water from Example 1 in two stages. Initial processing was performed by subjecting water with quality as shown in Example 1 through the electrocoagulation process which effectively removed suspended solids, iron, silica & silicon, bacteria and oil & grease. The treated water was allowed to settle for several minutes and then clarified through a simple media filter to remove remaining unsettled solids. This water was then subjected to second stage processing which significantly removed Total Hardness including Magnesium & Calcium and other hardness ions. All processing was done at room temperature (e.g., 20° C.).

| | Before | | After | % | |
|---|---|---|---|---|---|
| Parameter | Treatment | | Treatment | Reduction | Comments |
| Total Hardness | 24,000 | mg/L | 350 mg/L | 98.54% | Almost total removal of Scaling |
| (as CaCO₃) | | | | | Species |
| pH | 6.8 | | 7.0-7.4 | | |
| Total Suspended | 1740 | NTU | 1.64 NTU | 99.91% | Processed water is visually |
| Solids | | | | | crystal clear |
| Iron | 16 | mg/L | Undetected | >99.99% | Almost total Iron removal |
| Calcium | 7800 | mg/L | See Total | 98.54% | |
| Magnesium | 840 | mg/L | Hardness | | |
| Silicon | 14.4 | mg/L | 1.9 | 87.10% | |
| Total Bacteria | | | >99.9% Kill | 99.9% | 3 orders magnitude reduction. |
| (IRB, SRB) | | | Rate | | |
| Oil & Grease | 6.6 | mg/L | Undetected | >99.99% | Almost total Oil & Grease |
| (Method 1664) | | | | | removal |

| | | |
|---|---|---|
| Volatile Organic | Removed to | Up to 50% of the hydrocarbons |
| Compounds | low level | are removed from the aqueous |
| | | phase. Other hydrocabons are |
| | | broken down to low levels of |
| | | water soluble hydrocarbons, in |
| | | particular acetone. |

### Example 3

The rate of flocculation and the water clarity using methods of the invention was compared with other conventional methods.

When compared to conventional methods such as polymer or PAC1 addition, methods of the invention produced flocculates faster. Also, in treating high brine concentrations the addition of PAC1's and other polymers are prohibitive due to the fact that a large amount of the polymers are needed with high brine levels. In addition, flocculates produced by methods of the invention separated from the water and formed what appeared to be a relatively more “unified mass” of flocculates more readily. Furthermore, visually the size of flocculates appeared to be larger using methods of the invention.

Significantly, the flocculates produced by methods of the invention appeared to settle faster and produced clarified water faster than the other processes. In addition, it was observed that the flocculates produced by methods of the invention appeared to coagulate and/or attach to other material more rapidly than the flocculates from the other processes. For example, when a pipette was inserted to take a water sample, the flocculates had a much greater tendency to stick to the pipette than the flocculates formed from other processes. Without being bound by any theory, it is believed that the flocculates produced by processes of the invention have a greater affinity for forming a mass (e.g., coagulate) than other processes.

### Example 4

The following data set shows the effect of electrocoagulation with and without the addition of chlorine generated electrically immediately prior to entering the EC device.

Produced Water Treated at Different Temperatures with and without Chlorine

| | | | | 85° F. EC and | |
|---|---|---|---|---|---|
| | Untreated | 85° F. | % | Chlorine | % |
| | Water | EC only | Reduction | Electrolyzer | Reduction |
| pH | 6.59 | 7.88 | N/A | 6.48 | N/A |
| Conductivity (mS/cm) | 29.7 | 29.2 | N/A | 29.7 | N/A |
| ORP (mV) | 19.8 | 101.8 | N/A | 856 | N/A |
| Bacteria (present or not) | + | + | N/A | − | N/A |
| Silica (ppm) | 50 | 15.2 | 69.60% | 9.2 | 81.60% |
| Total Suspended Solids (ppm) | 770 | 8 | 98.96% | 3 | 99.61% |
| Total Dissolved Solids (ppm) | 16300 | 17100 | N/A | 17800 | N/A |
| Total Iron (ppm) | 30 | 0.81 | 97.30% | 0.15 | 99.50% |
| Chloride (ppm) | 15000 | 9625 | 35.83% | 10300 | 31.33% |
| Sulfate (ppm) | 288 | 7 | 97.57% | 7 | 97.57% |
| Turbidity (NTU) | 86.8 | 5.44 | 93.73% | 1.99 | 97.71% |
| Ca hardness as CaCO₃ (ppm) | 1445 | 1350 | 6.57% | 1335 | 7.61% |
| Total hardness as CaCO₃ (ppm) | 1625 | 1535 | 5.54% | 1555 | 4.31% |
| Ca²⁺ (ppm) | 578 | 540 | 6.57% | 534 | 7.61% |
| Chlorine (ppm) | ND | ND | N/A | 130 | N/A |
| Barium (ppm) | 100 | 16 | 84.00% | 17 | 83.00% |

### Example 5

The following data set shows the same data as above, but at a higher temperature demonstrating that high temperatures does not negatively effect EC performance and in some instances, gives better results.

Produced Water Treated at Different Temperatures with and without Chlorine

| | | | | 120° F. EC | |
|---|---|---|---|---|---|
| | Untreated | 120° F. | % | and Chlorine | % |
| | Water | EC only | Reduction | electrolyzer | Reduction |
| pH | 6.59 | 7.91 | N/A | 7.8 | N/A |
| Conductivity (mS/cm) | 29.7 | 30.4 | N/A | 29.5 | N/A |
| ORP (mV) | 19.8 | 239 | N/A | 239 | N/A |
| Bacteria (present or not) | + | + | N/A | − | N/A |
| Silica (ppm) | 50 | 13.6 | 72.80% | 6.1 | 87.80% |
| Total Suspended Solids (ppm) | 770 | 1 | 99.87% | 2 | 99.74% |
| Total Dissolved Solids (ppm) | 16300 | 15500 | 4.91% | 16400 | N/A |
| Total Iron (ppm) | 30 | 0.2 | 99.33% | 0.04 | 99.87% |
| Chloride (ppm) | 15000 | 8500 | 43.33% | 11000 | 26.67% |
| Sulfate (ppm) | 288 | 7 | 97.57% | ND | 100.00% |
| Turbidity (NTU) | 86.8 | 0.71 | 99.18% | 0.4 | 99.54% |
| Ca hardness as CaCO₃ (ppm) | 1445 | 1355 | 6.23% | 1330 | 7.96% |
| Total hardness as CaCO₃ (ppm) | 1625 | 1510 | 7.08% | 1470 | 9.54% |
| Ca²⁺ (ppm) | 578 | 542 | 6.23% | 532 | 7.96% |
| Chlorine (ppm) | ND | ND | N/A | 30.8 | N/A |
| Barium (ppm) | 100 | 17 | 83.00% | 17 | 83.00% |

In both examples above, the reader can see clear advantages of combining on-site addition of bleach or electrically generated chlorine prior to the electro coagulation process to oxidize iron and sulfur and other metals as well as produce a lower turbidity (i.e. “cleaner”) treated water product that can be further treated to remove additional hardness and salts.

### Example 6

The following example shows how increasing the EC cell current (dosage rate) results in greater removal of compounds from water. Increasing residence time will accomplish similar results, however, a key objective of applications in industry or the energy sector require treatment of large volumes of water, thus the design of the EC cells allows for scaleable high volume water treatment and the current applied has a strong effect on the ability of the EC cell to remove contaminants

Produced Water Treated at Different EC Cell Currents

| | Untreated | Amp*min/gal | | | | Final % |
|---|---|---|---|---|---|---|
| | Water | 30 | 60 | 90 | 200 | Reduction |
| pH | 7.7 | 8.4 | 8.3 | 8.4 | 9.1 | N/A |
| Specific Conductance | 10500 | 10300 | 10200 | 10500 | 11000 | N/A |
| (μmhos/cm) | | | | | | |
| Aluminum (ppm) | ND | 3.82 | 9.05 | 17.8 | 11.6 | N/A |
| Barium (ppm) | 4.86 | 2 | 1.16 | 1.04 | 0.0327 | 99.33% |
| Boron (ppm) | 12.5 | 12.4 | 12 | 11.8 | 10.8 | 13.60% |
| Calcium (ppm) | 12.4 | 14.3 | 10.1 | 5.78 | 0.936 | 92.45% |
| Iron (ppm) | 0.844 | 0.222 | 0.154 | 0.197 | ND | 100.00% |
| Magnesium (ppm) | 2.31 | 2.73 | 2.5 | 2.22 | 0.868 | 62.42% |
| Sodium (ppm) | 2330 | 2380 | 2220 | 2290 | 2350 | |
| Chloride (ppm) | 1980 | 1810 | 1720 | 1910 | 1900 | 4.04% |
| Sulfate (ppm) | 10.9 | 11.4 | 10.2 | 10.2 | 12 | |
| Alkalinity, Bicarbonate | 2490 | 2540 | 2560 | 2570 | 1850 | 25.70% |
| as CaCO₃ (ppm) | | | | | | |
| Alkalinity, Carbonate | ND | ND | ND | ND | 481 | |
| as CaCO₃ (ppm) | | | | | | |
| Alkalinity, Total | 2490 | 2540 | 2560 | 2570 | 2330 | 6.43% |
| as CaCO₃ (ppm) | | | | | | |
| Total Suspended Solids (ppm) | 8 | 18 | 26 | 30 | 36 | |
| Total Dissolved Solids (ppm) | 5680 | 5730 | 5470 | 6350 | 5600 | |
| Total Hardness (ppm) | 43.6 | 52 | 44 | 40 | ND | 100.00% |
| Silica (ppm) | 78.5 | 41.5 | 44.1 | 13.6 | 1.93 | 97.54% |
| Benzene (ppm) | 7.33 | 1.83 | 3.6 | 2.85 | 0.801 | 89.07% |
| Ethylbenzene (ppm) | 0.143 | ND | ND | ND | ND | 100.00% |
| Toluene (ppm) | 7.55 | 1.49 | 3.04 | 2.39 | 0.531 | 92.97% |
| Xylenes, Total (ppm) | 1.7 | 0.256 | 0.524 | 0.42 | 0.0665 | 96.09% |
| Oil and Grease (ppm) | 29.9 | ND | ND | ND | ND | 100.00% |
| Methanol (ppm) | 89.7 | 68.7 | 70.3 | 65.3 | 81.8 | 8.81% |
| Total Organic Carbon (ppm) | 294 | 312 | 295 | 310 | 275 | 6.46% |

### Example 7

The following example looks at the effect of treating PW by electrocoagulation combined with air stipping for high removal rates of volatile organic carbons (VOCs) from water. Up to 50% of the VOC's are removed in the EC process followed by near 100% total removal by the combined EC and air stripping process.

Produced Water Treated by Electro coagulation and Air Stripper

| | Pre- | Post- | % |
|---|---|---|---|
| Volatile Organics | treatment | treatment | Reduction |
| Acetone (ppm) | 69.9 | 44.1 | 36.91% |
| Benzene (ppm) | 0.0984 | ND | 100.00% |
| 2-Butanone (ppm) | 0.232 | ND | 100.00% |
| n-Butylbenzene (ppm) | 0.0168 | ND | 100.00% |
| sec-Butylbenzene (ppm) | 0.0056 | ND | 100.00% |
| Chloroform (ppm) | 0.0154 | ND | 100.00% |
| Dibromomethane (ppm) | 0.0083 | ND | 100.00% |
| Ethylbenzene (ppm) | 0.0115 | ND | 100.00% |
| p-Isopropyltoluene (ppm) | 0.0069 | ND | 100.00% |
| n-Propylbenzene (ppm) | 0.0067 | ND | 100.00% |
| Toluene (ppm) | 0.23 | ND | 100.00% |
| 1,2,4-Trimethylbenzene (ppm) | 0.0892 | ND | 100.00% |
| 1,3,5-Trimethylbenzene (ppm) | 0.0411 | ND | 100.00% |
| Xylene, Total (ppm) | 0.234 | ND | 100.00% |

### Example 8

Similar to Example 7, the following example looks at the effect of treating PW with electrocoagulation combined with air stipping for high removal rates of semi-volatile organic carbons (SVOCs) from water. Up to 50% of the SVOC's are removed in the EC process followed by near 100% total removal by the combined EC and air stripping process.

Produced Water Treated by Electro coagulations and Air Stripper

| | Pre- | Post- | % |
|---|---|---|---|
| Semi-Volatile Organics | treatment | treatment | Reduction |
| 2,4-Dimethylphenol (ppm) | 0.221 | ND | 100.00% |
| 1-Methylnaphthalene (ppm) | 0.0303 | ND | 100.00% |
| 2-Methylnaphthalene (ppm) | 0.0754 | ND | 100.00% |
| 2-Methylphenol (ppm) | 1 | ND | 100.00% |
| m&p Cresol (ppm) | 0.836 | ND | 100.00% |
| Naphthalene (ppm) | 0.0128 | ND | 100.00% |
| Phenanthrene (ppm) | ND | ND | N/A |
| Phenol (ppm) | 1.71 | ND | 100.00% |

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

| | | | |
|---|---|---|---|
| 10 | electrocoagulation device | 300 | non-electrically conducting connector |
| | | 304 | electrical shielding element |
| 100 | tube | 200 | tube insert |
| 104 | inner diameter of tube 100 | 204 | outer diameter of tube insert 200 |
| 108 | outer diameter | 208 | spacer element |
| 112 | first orifice | 212 | outer surface |
| 116 | second orifice | 216 | plurality of protuberances |
| 120 | inner surface | 220 | fluid inlet |
| 124 | outer surface | 224 | plurality of fluid outlet orifices |
| 128 | plurality of electric nodes | 228 | electrically conducting tube portion |
| 132 | conducting element | 232 | electrically conducting solid portion |

What is claimed is:

1. An electrocoagulation device comprising:
(a) an electrically conducting tube comprising:
an inner diameter,
an outer diameter,
a first orifice, and
a second orifice distal to said first orifice for allowing a fluid to flow out of said electrocoagulation device;
(b) an electrically conducting tube insert located and positioned within said tube such that there is an annular space between said tube and said tube insert, wherein said tube insert comprises:
a fluid inlet located proximal to said first orifice of said tube for allowing a fluid to flow into said electrocoagulation device, and
a plurality of fluid outlet orifices for allowing a fluid to flow out of said tube insert and into the annular space of said electrocoagulation device; and
(c) a non-electrically conducting connector located proximal to said first orifice and connecting said tube and said tube insert such that said tube and said tube insert are electrically isolated from one another,
wherein one of said tube and said tube insert forms an anode and the other forms a cathode of the electrocoagulation device.

2. The electrocoagulation device of claim 1, wherein said tube is a metallic tube.

3. The electrocoagulation device of claim 2, wherein said tube comprises aluminum, copper, nickel, zinc, silver, titanium, iron, stainless steel, monel, or a combination thereof.

4. The electrocoagulation device of claim 1, wherein said tube insert comprises (a) an electrically conducting tube portion comprising said fluid inlet and said plurality of fluid outlet orifices and (b) an electrically conducting solid portion.

5. The electrocoagulation device of claim 4 further comprising an electrical shielding element surrounding said electrically conducting tube portion such that when said device is in operation the flow of electricity between said electrically conducting tube and said electrically conducting tube portion is substantially reduced.

6. The electrocoagulation device of claim 4, wherein said electrically conducting tube portion and said electrically conducting solid portion are removably attached to one another.

7. The electrocoagulation device of claim 4, wherein said plurality of fluid outlet orifices is located proximal to said first orifice of said tube.

8. The electrocoagulation device of claim 4, wherein said solid portion comprises a metal, electrically conducting polymer, or a combination thereof.

9. The electrocoagulation device of claim 8, wherein said solid portion comprises monel, titanium, aluminum, copper, nickel, zinc, silver, electrically conducting polymer, iron, or a combination thereof.

10. The electrocoagulation device of claim 8, wherein said solid portion comprises iron, aluminum, or a mixture thereof.

11. The electrocoagulation device of claim 4, wherein said electrically conducting solid portion comprises a plurality of protuberances.

12. The electrocoagulation device of claim 11, wherein said plurality of protuberances comprise a non-electrically conducting material thereby preventing a direct electrical contact between said tube and said tube insert.

13. The electrocoagulation device of claim 1, wherein said tube insert comprises a plurality of protuberances.

14. The electrocoagulation device of claim 13, wherein said plurality of protuberances comprises a non-electrically conducting material.

15. The electrocoagulation device of claim 1, wherein each of said fluid inlet and said second orifice further comprises a T-joint adapted to allow purging of said electrocoagulation device.

16. A water treatment process for treating water comprising suspended solids, dissolved fine solids, or a combination thereof, said treatment process comprising:
precipitating at least a portion of suspended or dissolved fine solids by electrocoagulation process using an electrocoagulation device of claim 1; and
separating at least a portion of the precipitated solid to produce a treated water that comprises a reduced amount of suspended solids, dissolved fine solids, or a combination thereof.

17. The water treatment process of claim 16 further comprising the step of removing a hardness ion from the treated water.

18. The water treatment process of claim 16, wherein the hardness ion is selected from the group consisting of calcium, magnesium, strontium, barium, and a mixture thereof.

19. The water treatment process of claim 16, wherein said step of precipitating at least a portion of the hardness ion comprises adding a carbonate ion source to the treated water.

20. The water treatment process of claim 19, wherein the carbonate source comprises trona, an alkaline metal carbonate, an alkaline earth metal carbonate, an alkaline metal bicarbonate, an alkaline earth metal bicarbonate, carbon dioxide, or a combination thereof.

21. The water treatment process of claim 16 further comprising removing at least a portion of chloride ions that is present in the water.

22. The water treatment process of claim 21, wherein said step of removing chloride comprises an electrolytic process or ultraviolet light process.

23. The water treatment process of claim 16 further comprising the step of non-chemically generating hydroxide ions from water molecules.

24. The water treatment process of claim 23, wherein said step of non-chemically generating hydroxide ions comprises using corona discharge, sonic cavitation, hydrodynamic cavitation, electron beam, particle beam, or a combination thereof.

25. The water treatment process of claim 16 further comprising precipitating at least a portion of ferric ions, aluminum ions, silica, hydrocarbon, or a combination thereof.

26. The water treatment process of claim 16, wherein said process removes at least a portion of hydrocarbons, metal ions, sulfates, silica, chemical oxygen demand (COD) and biological oxygen demand (BOD) or a combination thereof.
